(19) United States
(12) Patent Application Publication
(10) Pub. No.: US 2012/0266085 A1
(43) Pub. Date: Oct. 18, 2012

(54) Guidance System and Method for Identifying a Component of a Complex Product or System

(75) Inventors: Lars Åman, Lidingo (SE); Anders Åman, Stockholm (SE)

(73) Assignee: QUICKPILOT AB, Stockholm (SE)

(21) Appl. No.: 13/508,773

(22) PCT Filed: Nov. 8, 2010
(86) PCT No.: PCT/EP2010/067001

§ 371 Date: Jun. 26, 2012

(30) Foreign Application Priority Data
Nov. 9, 2009 (EP) 09175427.5

(51) Int. Cl. G06F 3/01; G06F 15/16

(52) U.S. Cl. 715/753

(57) ABSTRACT

A system for local client stations connected to a web server connecting with a database server enables a local client station to identify a necessity in a complex product or system, such as a detail or a spare part, in a commercially available store or stock storage of an arbitrary location, in order to provide guidance and replacement parts to a user. Any combination of verbal or figurative overview is presented to the user at an overarching structural level from which the user interactively can choose, via an interactive interface and based on memorizable facts, to a next, less over-arching structural level, in at least two steps, until at a level corresponding to a detail level (target level) at which an item sought for is found. Choices can be made based on facts corresponding to the memorizable facts carried along and displayed on the actual detail level.

### FIELD OF THE INVENTION

The present invention relates to a system and a method as referred to in the first parts of the independent claims, and for anyone in identifying a necessity for a complex product or system such as a detail or a spare part, commercially available in a store or stock storage of an arbitrary branch, such as a spare part for a lawn mover, a car or similar with a specified origin and/or detail number. The invention also relates to a local client station at which such information can be obtained.

### BACKGROUND

When people are faced with finding the correct component or relevant piece of information for solving a constructional problem or a dysfunction of some kind in a more or less complex device or construction, a detail or a spare part must be identified and localized. Since good craftsmen nowadays either have become too expensive or too hard to find, there is a tendency in people to try to solve a lot more things on their own than traditionally was the case. As a consequence different kinds of stores have been established in trying to provide such details or spare parts to the more or less knowledgeless layman. Providing this can be quite complex and do require quite some knowledge, empathy, patience and understanding from employees trying to understand what is requested, dependent on which branch one focuses on. All these necessary personal characteristics can be learned, however, it costs money to provide education. Also people that normally accept working with helping said laymen in finding what they search for, tend to be people that accept jobs of this kind for a shorter time period. This means that there is a more or less constant demand on renewal of such staff and also a constant demand on education of new people before being able to serve as shop attendants or the like in serving clients to buy the correct e.g. spare part or obtain the relevant information. In spite of the fact that the attendants get educated it is still always the respective attendants' appearance and actual knowledge that determine whether the client or customer assimilate the correct advice or not and gets to buy the correct spare part. All of this is of course unsatisfactory and it is therefore the purpose of the present invention to define a system and a method by which it is no longer necessary to, or at least to a lower extent, use and rely on human attendants to guide people to the correct information or buy in each specific situation.

### SUMMARY OF THE INVENTION

A primary objective of the present invention is to provide a system and a method respectively which gives a client the possibility to, when in a situation trying to find a solution to a specific decisive situation, e.g. before buying something that rectifies, improves or modifies, in a desired manner, the situation, gives the correct support in making the correct decision at each specific client's own intellectual level. It is also an object of the invention to provide a system, a method and a client station facilitating for manufacturers deliverers, shops and users provisioning/accessing specific information/parts of products when the user has no detailed starting information or not sufficient information e.g. about the product of which a certain sub-product or item forms a part. It is particularly an object to provide fast and easy access for a sparsely informed user to a desired detailed piece of information concerning an initially unspecified item.

Therefore a system and a method respectively having the characterizing features of claims 1 and 16 respectively are provided. Therefore also a client station as initially referred to is provided which has the characterizing features of claim 8.

Advantageous embodiments are given by the features of the sub-claims. According to the invention particularly any combination of a verbal or figurative overview is presented at an overarching structural, or higher hierarchical, level from which a choice based on memorisable facts can be made to a next, less over-arching, or lower hierarchical, structural level, in at least two steps, until at a level corresponding to a detail level at which an item or a piece of information sought for is found, a choice is made based on facts displayed on the actual detail level (target level).

For a client it will thereby be possible to, in an iterative fashion, step-by-step, advance towards a desirable result without need for any person-to person guidance or assistance. By the fact that all symbols used in the presentation or guidance are generated using a cognitive ergonomic method, it will be possible to guide almost anyone with a normal intelligence towards said desirable result.

The invention moreover, according to a further objective makes it possible, at said target level, to a client, extract and supply instructive pictorials or film sequences such as disassembly instructions, assembly instructions and instructions for use in order to provide added value to the client.

Furthermore, to the organisation that implements a method according to the invention, it will be able to provide an extra “salesperson” for each presentational interface that is exposed. Said “sales person” as such will never get ill, never take a holiday and will never take a break.

According to a further developed embodiment of the invention the client may at said target level be able to extract and be supplied, with e.g. optionally, or selectably, either instructive pictorials, with or without lingual descriptions, film sequences such as disassembly, assembly instructions and instructions for use, particularly optionally audio information.

Such embodiments will no doubt further increase the joy of the layman, user, when he or she discovers that it with proper guidance is possible to achieve things that before seemed more or less impossible to.

Such pictorials or film sequences may be provided as hard-ware or as soft-ware via e-mail or blue-tooth communication with for instance a mobile telephone or a personal computer. In its present appearance the present invention provides inevitable sales support to complex products, the access to which can be invaluable both to the sales organisation and to the client.

By furthermore using computerized guidance interfaces it is possible for the sales organization to expand its sales area even to selling goods in stock. For travelling sales persons it gives immediate control of availability and possible deliveries due to contact over the Internet.

When the invention is completely computerized, it teaches the sales organisation more about its customers by the possibility to collect and store information about clients as well as purchased items and handle such information for the good of developing the product mix or range. It will also be possible to activate promotional offers directly as well as to create individual offers.

It will also be an aid in gathering different kinds of help and safety regulations.

### BRIEF DESCRIPTION OF THE DRAWINGS

The invention will in the following be described more in detail in a non-limiting manner, and with reference to the accompanying drawings, in which:

FIG. 1 shows a flow diagram over a generic method for anyone to identify a necessity for a complex product or system,

FIG. 2 is a schematical block diagram of a system according to the invention,

FIG. 3 shows as a front view a visualisation of an access station, i.e. a local client station, according to the invention, and

FIG. 4 shows said access station as a side view from its left side.

### DETAILED DESCRIPTION OF THE INVENTION

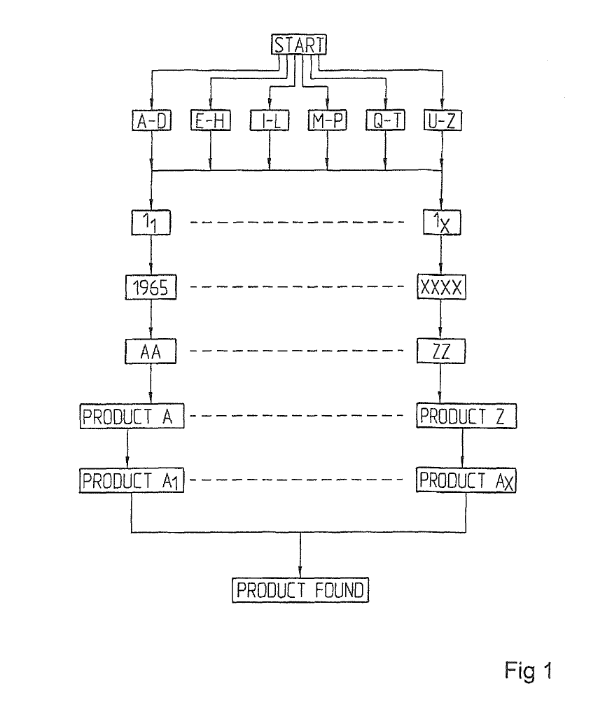

According to FIG. 1, a generic flow diagram is shown for realizing a method according to the invention. At an uppermost level thereof at “start”, an entrance (1) to a more and more refined maze (2) is defined. Said entrance (1) may be in the form of a refined catalogue system comprising cross-references to other parts of said entrance catalogue or to another catalogue, which in its turn may define a lower more detailed level of cross-references to other parts of the catalogue system or perhaps shows an article sought for in a product mix, which is specific for a certain branch or business operation. While iterating oneself along the way down said maze (2), it is essential that the person performing the search is aware of that certain “inputs” are given in the form of intelligent part-taking in decision making in order to be able to proceed further towards the goal, which is to find a certain article, or a certain piece of information, pertaining to the branch in question, sought for, such as a spare part for an automobile. A most essential part of the iterative process in reaching said goal is that it is supposed that the process is supposed to proceed in spite of the fact that the person using the same is unable to receive any kind of help in reaching the goal, in other words, the iterative process must be provided with directional advice contained in connection with each step that is more than good enough to make the person able to in a decisive fashion take a stand.

From the entrance at (1) marked “start”, different paths such as A-D, E-H, I-L etc. are electable based on information provided by the user of the method. Each such path, for instance A-D, in succession gives a number of possible choices 1₁ to 1ₓ, which after being elected gives free pass to another level of choices 1965 to 20XX, and so on until the correct component or subcomponent is found and if the method is software implemented where the same is stored.

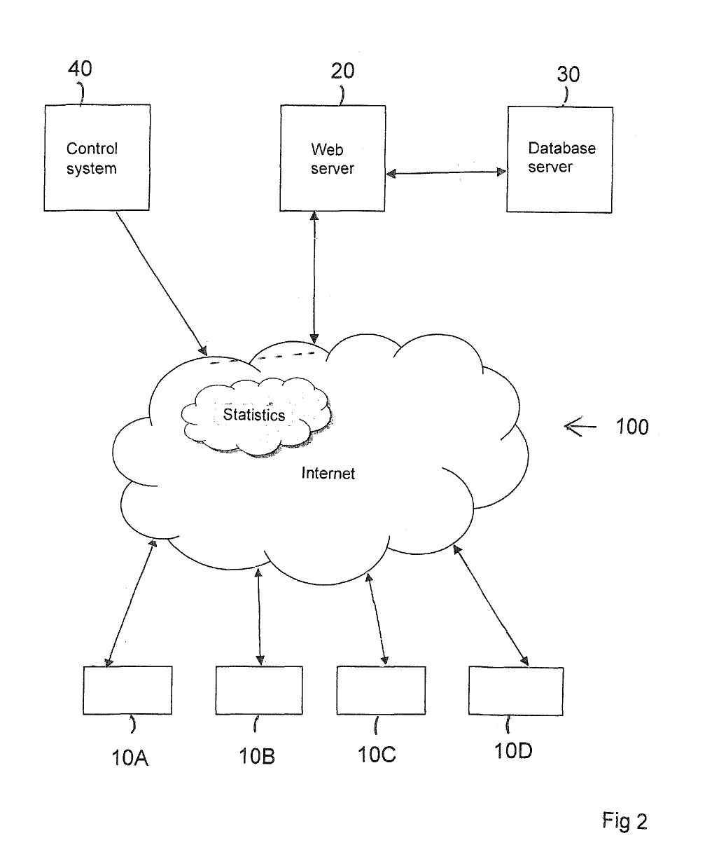

FIG. 2 schematically illustrates an overview of a system 100 according to the present invention. A plurality of local client stations 10A, 10B, 10C, 10D are located in for example different stores, shopping centres and gas stations. The system 100 comprises a web server 20 connected to or communicating with a database server 30, which form the core of the system. The database server 20 may comprise and be connectable to different information holders or databases and provides information about products, e.g. relating to different cars, clients, users, relations etc. By means of different functions and modules it is then possible to present the information to a user at a local client station based on a consecutive selection made by the user on an interactive touch screen 11 of a local client station. Interactively the user in consecutive steps applies relevant filters to get closer and closer to the desired information, e.g. by performing several (at least two) filtering selections. The user is then able to, via a web reader, at the local client station get access to a desired item or a desired piece of information when the information retrieval application at the web server has been downloaded and is activated and run in the client station.

A control system 40 may be provided with which the web server 20 communicates over Internet (e.g. over an integration interface), which controls which client (local client station) should get access to which information, e.g. of which business field or product field etc.

Particularly specific codes or rules concerning each respective client station are stored in the database server.

An individual local client station may comprise or be connected to a scanner and/or to a loudspeaker.

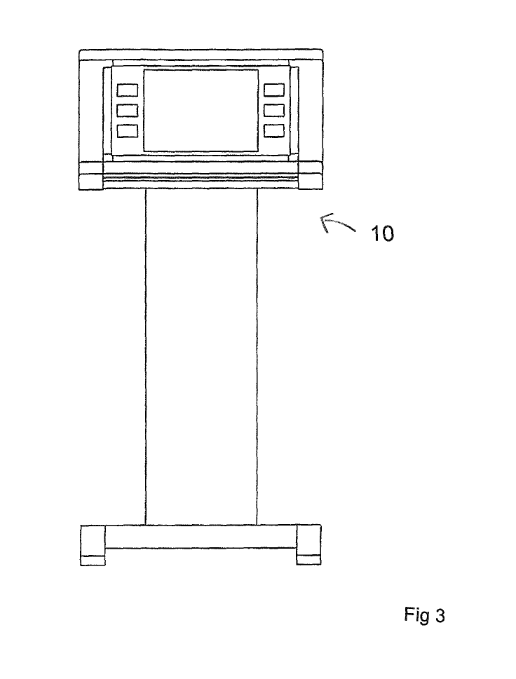

As is shown in FIG. 3, which schematically illustrates a local client station 10, the method of the invention may very well be exercised in the form of a software-system implemented to be used with the aid of an easily handled touch sensitive computer-screen, which in turn might be part of a more complex computer architecture, part of which in turn can be for example an advanced ERP-system (Enterprise Resource Planning system). By being connected in such a system, the client can always get advice with regard to availability, if not immediate. The possibilities to provide helping instructions is by implementation of the method via software largely enhanced.

The method and the system according to the invention in which said presentation is made, make use of software installed in a personal computer or a computer server connected to or comprised by the local client stations or work-stations.

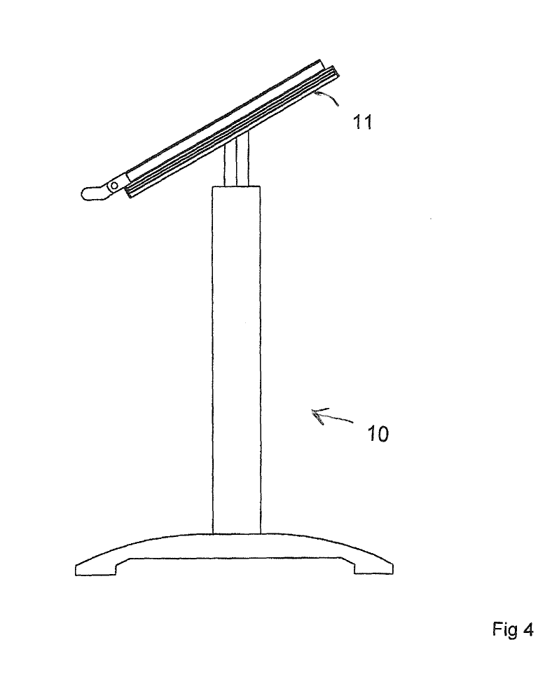

The local client station may be fixed or mobile, preferably ergonomically disposed, making it easy for a user to access the information retrieval application cf. the side view of the local client station 10 in FIG. 4, where it is arranged such that a person in a standing, upright position easily can interact via the user interface and view the information shown on the display screen.

In a particular embodiment the display and user interface can be displacably or adjustably arranged on a carrying structure, such that it can be set at a user selected height. Preferably the inclination of viewing angle of the display/user interface can also be set by a user, i.e. it can be pivotably arranged on a horizontal axis or similar.

The computer or computer-server may be integratedly combined with a bar code reader (not shown), also either stationary or mobile, so that a client may pick an item from anywhere such as a shelf in a store to, and by using said reader, have the items bar code decoded in order to verify the items compatibility with the product for which relief is sought.

Furthermore the method according to the invention may be provided as a combination of at least one search facility like a catalogue with, when the correct spare part is found, the delivery of one or more hardware spare parts or details together with USB-memories or software based instructions provided for instance via a Bluetooth interface containing said software based information, to be displayed in a computer or on a cell phone, that upon activation displays all necessary information and steps needed for mounting or replacing said spare part or detail.

The invention is not limited to only the above generically described examples but should instead be limited only by the enclosed claims.

1.-18. (canceled)

19. A system for enabling a user to obtain information relating to a complex system or product, the system comprising:
a plurality of local client stations configured for connecting to a core system that communicates with a number of central information holders configured for holding information relating to the complex system or product,
wherein the core system includes a web server having or communicating with a database server that includes or communicates with the central information holders,
each local client station includes a web reader and a user interface having an interactive screen, and is configured for communicating with the web server and running an information retrieval application, and
at least one local client station is configured for presenting, upon running the information retrieval application, an audio/visual overview to the user at an overarching structural level of the complex system or product; for enabling the user to interactively choose from the overview at least one less over-arching structural level until a structural level at which a user-desired information is presented; and for extracting and providing, using the information retrieval application and the web reader, to the user either instructive audio/video sequences or images with or without audio descriptions relating to disassembly, assembly, or use of the complex system or product.

20. The system of claim 19, wherein the web server includes a client retrieval application for identifying information and is configured for communicating with an access control system having control information about which information relating to a complex system or product is accessible by a local client station.

21. The system of claim 19, wherein the information retrieval application is configured for supplying at least one physical item and a memory device containing information for display at the local client station relating to the complex system or product.

22. The system of claim 19, wherein the information retrieval application is configured for supplying at least one physical item and for supplying software-based information to a user device that upon activation displays the information relating to the complex system or product.

23. The system of claim 19, wherein at least one of the local client stations comprises a scanner.

24. The system of claim 19, wherein at least one of the local client stations comprises a loudspeaker.

25. The system of claim 19, wherein a local client station includes a bar-code reader for user selection of an item from a store of items.

26. A local client station for enabling a user to obtain information about relating to a complex product or system, the local client station being configured for communicating with a core system a number of information holders with information about a number of complex products or systems, the local client station comprising:
a web reader configured for running an information retrieval application for downloading information from the core system, and
a user interface, comprising an interactive display screen,
wherein the local client station is configured for presenting, upon running the information retrieval application, an audio/visual overview to the user at an overarching structural level of the complex product or system; for enabling the user to interactively choose from the overview at least one less over-arching structural level until a structural level at which a user-desired information is presented; and for extracting and providing, using the information retrieval application and the web reader, to the user either instructive audio/video sequences or images with or without audio descriptions relating to disassembly, assembly, or use of the complex product or system.

27. The local client station of claim 26, wherein the local client station is configured for displaying, upon user interaction on the screen and at the structural level at which the user-desired information is presented, information needed for mounting or replacing a part of the complex product or system.

28. The local client station of claim 26, wherein the local client station is configured for communicating with a user device that upon activation displays the information relating to the complex product or system.

29. The local client station of claim 26, wherein the local client station comprises a scanner.

30. The local client station of claim 26, wherein the local client station comprises a loudspeaker.

31. The local client system of claim 26, wherein the user interface is configured for receiving and acting on voice instructions.

32. The local client station of claim 26, further comprising a bar-code reader for user selection of an item from a store of items.

33. The local client system of claim 26, wherein the local client station further comprises a mobile or fixed helpdesk.

34. The local client system of claim 33, wherein the mobile or fixed helpdesk is adjustably mounted on a carrying structure.

35. A method of enabling a user to obtain information relating to a complex product or system from a local client station running an information retrieval application and having an interactive user interface, the method comprising:
activating the information retrieval application;
presenting, based on a choice by the user in the interactive user interface, an audio/visual overview on a display screen such that the user interactively can choose at least one less overarching structural level; and
upon user-identification of a structural level at which user-desired information is presented, displaying either instructive audio/video sequences or images with or without audio descriptions relating to disassembly, assembly, or use of the complex product or system.

36. The method of claim 35, wherein activating the information retrieval application includes reading a bar code of a product.
